(19) United States
(12) Patent Application Publication
(10) Pub. No.: US 2016/0049705 A1
(43) Pub. Date: Feb. 18, 2016

(54) HEAT-EXCHANGE PANEL FOR BATTERY HEAT MANAGEMENT AND ASSOCIATED PRODUCTION METHOD

(71) Applicant: VALEO SYSTEMES THERMIQUES, Le Mesnil-Saint-Denis (FR)

(72) Inventors: Christian Mahe, Le Tremblay Sur Mauldre (FR); Fabien Bireau, Guyancourt (FR); Georges De Pelsemaeker, Poigny-La-Foret (FR); Xavier Marchadier, Levis Saint Nom (FR)

(73) Assignee: VALEO SYSTEMES THERMIQUES, Le Mesnil-Saint-Denis (FR)

(21) Appl. No.: 14/779,984

(22) PCT Filed: Mar. 28, 2014
(86) PCT No.: PCT/EP2014/056336

§ 371 Date: Sep. 25, 2015

(30) Foreign Application Priority Data
Mar. 29, 2013 (FR) 1352901

(51) Int. Cl. H01M 10/6556; F28F 3/00; B23P 15/26; F28D 1/03

(52) U.S. Cl. CPC H01M 10/6556; F28D 1/03; F28F 3/00; B23P 15/26

(57) ABSTRACT

A heat exchange plate for battery thermal management is disclosed. The heat exchange plate includes a base having a circuit of ducts for the circulation of heat-transfer fluid or refrigerant between an inlet and an outlet for heat-transfer fluid, and, fixed to the base, a contact plate intended to come into contact with the battery to be thermally regulated and covering said ducts, the base being made of molded plastic material and the contact plate being produced in a thermo-conductive material. A manufacturing method for such a heat exchange plate is also disclosed.

The present invention relates to battery thermal regulation and more particularly the heat exchange plates for battery thermal management, notably in the motor vehicle domain. The invention relates also to the method for manufacturing heat exchange plates.

The thermal regulation of the batteries, notably in the motor vehicle domain and even more particularly in electric and hybrid vehicles, is an important aspect because, if the batteries are subjected to excessively cold temperatures, their power reserve can decrease greatly, and if they are subjected to excessively high temperatures, there is a risk of thermal runaway that can go as far as destruction of the battery.

In order to regulate the temperature of the batteries, it is known practice to add a temperature regulation device for the battery module. These devices generally use heat-transfer fluids or refrigerants circulating, for example by means of a pump or a compressor, in a duct circuit, said duct circuit passing notably under or inside a heat exchange plate in direct contact with the batteries.

The heat-transfer fluids or refrigerants can thus absorb heat emitted by the battery or batteries in order to cool them and discharge this heat on one or more heat exchangers such as, for example, a radiator or a condenser. The heat-transfer fluids can also, if necessary, add heat to heat up said batteries, for example if they are linked to a heating device such as an electrical resistor or to a heating by positive temperature coefficient (PTC).

The heat-transfer fluids generally used are ambient air or liquids such as water for example. The refrigerants used can be of the type of a refrigerant gas of R134a or equivalent type. Since liquids are better conductors of heat than air, this is a solution which is preferred because it is more effective.

Generally, the heat exchange plates are in direct contact with the batteries or at least one battery pack, by being placed under the latter. The heat exchange plates are generally made of metal and are made up of two metal plates stamped and brazed against one another in order to form one or more circuits of ducts for the circulation of the heat-transfer fluid or refrigerant between a fluid inlet and an outlet.

However, this type of heat exchange plate and its manufacturing method are still costly because they use costly materials and involve lengthy and energy-intensive manufacturing steps such as, for example, the brazing.

One of the aims of the invention is to propose a heat exchange plate that is economical and which nevertheless retains its properties of thermal energy transfer between the batteries and the heat-transfer fluid, as well as its manufacturing method.

The present invention therefore relates to a heat exchange plate for battery thermal management, comprising a base including at least one channel for the circulation of heat-transfer fluid or refrigerant between an inlet and an outlet for said fluid, and further comprising, fixed to said base, a contact plate intended to come into contact with the battery to be thermally regulated and covering each channel in order to form at least one duct for the circulation of heat-transfer fluid or refrigerant, the base being made of molded plastic material, the contact plate being produced in a thermo-conductive material.

The fact that the base is made of molded plastic material and that the contact plate is made of thermo-conductive material makes it possible for the heat exchange plate to be particularly inexpensive because of the use of inexpensive material, while retaining an optimal thermal conductivity between the battery and the heat-transfer fluid or refrigerant. The base made of plastic material also allows for a wider variety of fixing modes with the contact plate but also with the support onto which it is fixed. In addition, the base made of plastic material allows for a thermal insulation with the elements situated opposite the contact plate and also allows for a focusing of the heat exchanges in the ducts because of the low thermal conductivity of the plastic materials. The base made of molded plastic material, through its production method, also allows for the addition of elements or of particular shapes directly at the stage of its manufacture, which commensurately reduces its cost.

According to one aspect of the invention, the contact plate is made of metal.

According to another aspect of the invention, the base further comprises seals placed between said base and the contact plate in order to ensure the seal-tightness of the ducts.

According to another aspect of the invention, the fixing of the contact plate onto the base is produced by screwing.

According to another aspect of the invention, the fixing of the contact plate onto the base is produced by means of a casting of at least one stud made of a piece with the material of the base and passing through the contact plate.

According to another aspect of the invention, the fixing of the contact plate onto the base is produced by means of an overmolding of at least one complementary plastic part.

According to another aspect of the invention, the fixing of the contact plate onto the base is produced by means of a crimping of said contact plate on the base.

According to another aspect of the invention, the base includes a notch produced on one of its sides and into which is inserted a side of the contact plate, the side of said contact plate opposite that inserted into the notch being held against the base by means of at least one added element that clips onto the base.

According to another aspect of the invention, the fluid inlet and outlet are produced on the contact plate and each includes a coupling tube.

According to another aspect of the invention, each coupling tube includes a flange and the fixing of the coupling tube onto the contact plate being produced by an insertion of said coupling tube into a dedicated orifice of the contact plate, then by a crimping of the end of said coupling tube passing through the orifice in order to block the contact plate between, on the one hand, the flange and, on the other hand, the crimped end of said tube.

According to another aspect of the invention, the coupling tubes include a baseplate of a diameter greater than the orifices of the contact plate through which the coupling tubes pass through said contact plate and said baseplates being inserted between the contact plate and the base.

According to another aspect of the invention, the coupling tubes include a collar and at least two keys and the contact plate includes orifices including at least two notches for the passage of the keys, the fixing of the coupling tubes being produced by rotation of said coupling tubes in the orifices in order to place the lips of the orifices (70) of the contact plate between the keys and the collar.

According to another aspect of the invention, the heat exchange plate includes a phase-change material and/or a heating device and/or disruptors.

The present invention relates also to a manufacturing method for a heat exchange plate comprising the following steps:
molding of a base made of plastic material including a duct circuit for the circulation of heat-transfer fluid or refrigerant between an inlet and an outlet for heat-transfer fluid,
positioning of a contact plate made of thermo-conductive material on the base in order to cover the ducts,
fixing of the contact plate onto the base in a seal-tight manner.

According to one aspect of the method according to the invention, between the step of molding of the base and the step of positioning of the contact plate, an intermediate step is carried out for placing at least one seal on one or other of the base or of the contact plate in order to ensure the seal-tightness of the duct delimited by a channel of the base and the contact plate.

According to one aspect of the method according to the invention, said method includes a step of placing and fixing coupling tubes.

Other features and advantages of the invention will become more clearly apparent on reading the following description, given by way of illustrative and nonlimiting example, and the attached drawings in which:

FIG. 1 shows a schematic representation in section of a heat exchange plate according to one embodiment,

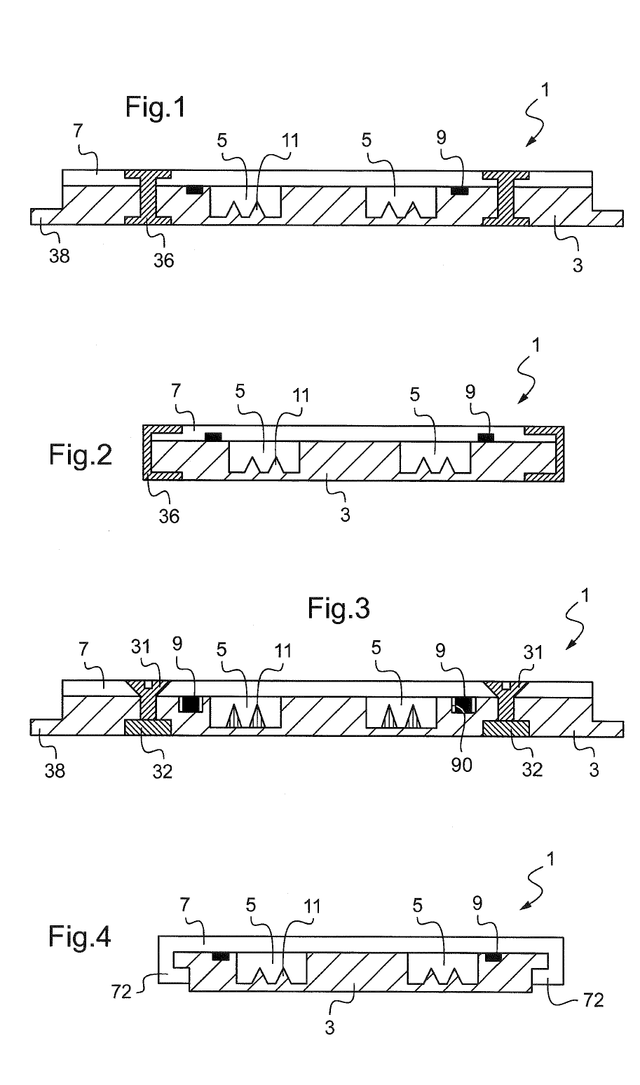

FIG. 2 shows a schematic representation in section of a heat exchange plate according to a first alternative embodiment,

FIG. 3 shows a schematic representation in section of a heat exchange plate according to a second alternative embodiment,

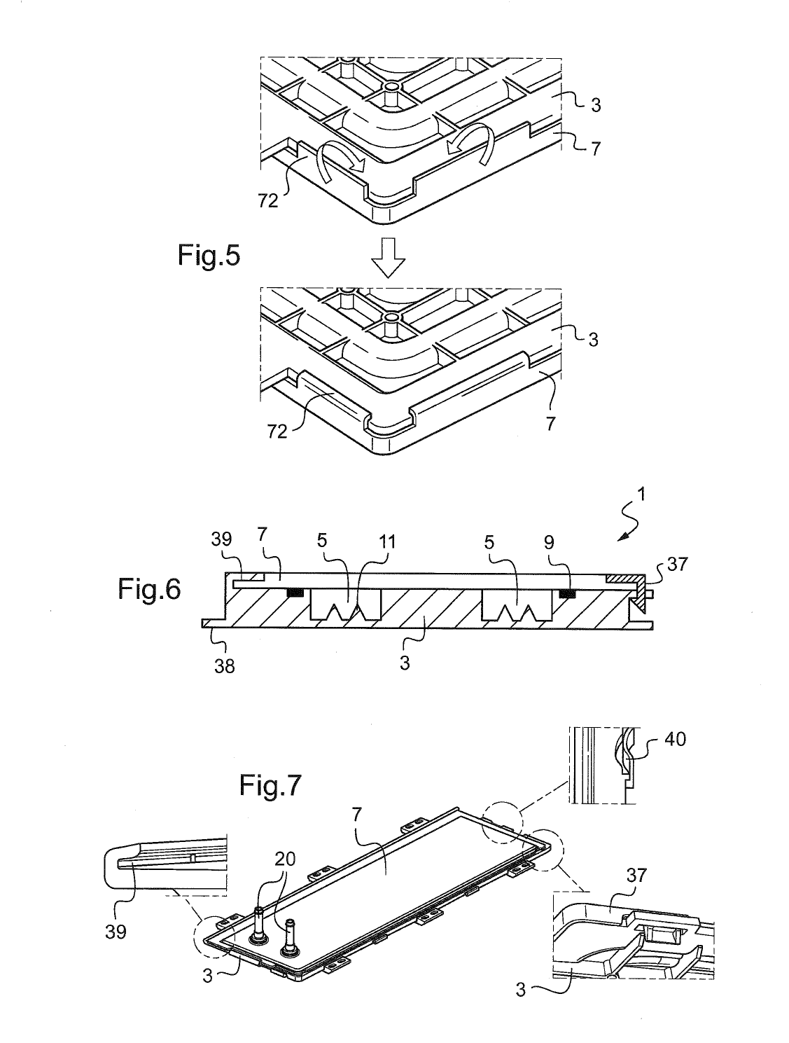

FIGS. 4 and 5 show a schematic representation, respectively in section and in perspective, of a heat exchange plate according to a third alternative embodiment,

FIGS. 6 and 7 show a schematic representation, respectively in section and in perspective, of a heat exchange plate according to a fourth alternative embodiment,

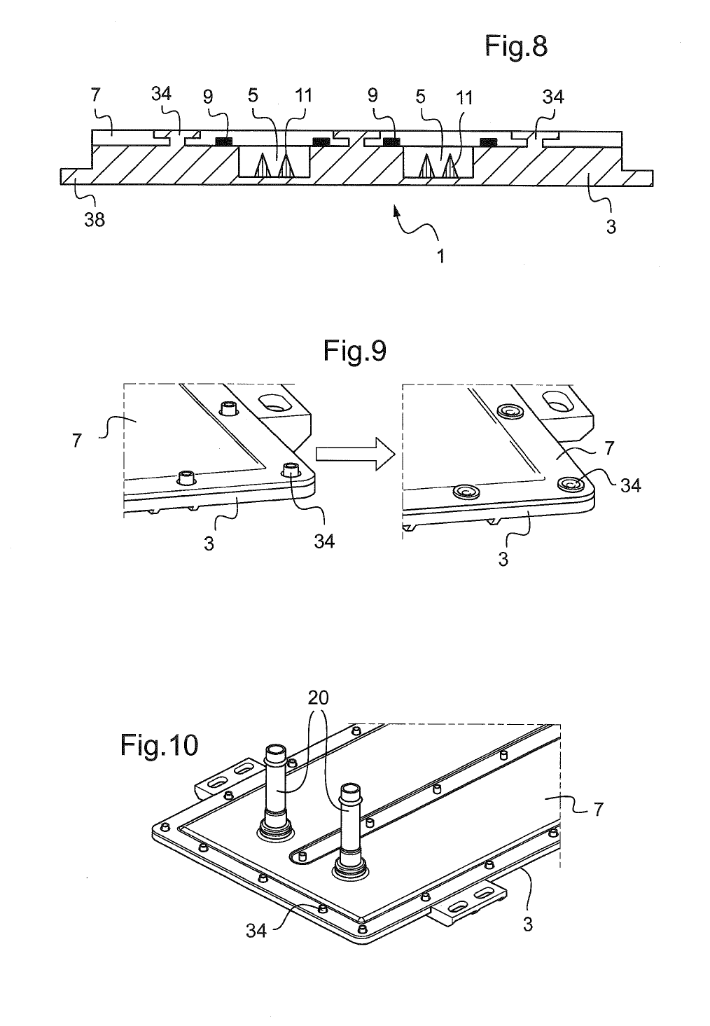

FIGS. 8 to 10 show a schematic representation, respectively in section and in perspective, of a heat exchange plate according to a fifth alternative embodiment,

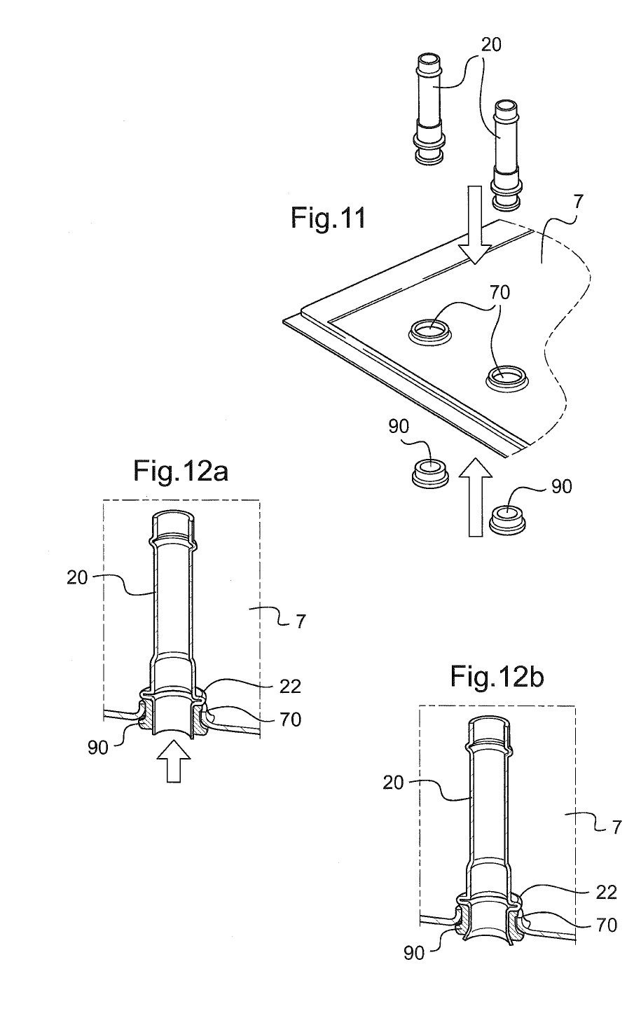

FIGS. 11 to 12b show a schematic representation in perspective of a coupling tube fixing mode,

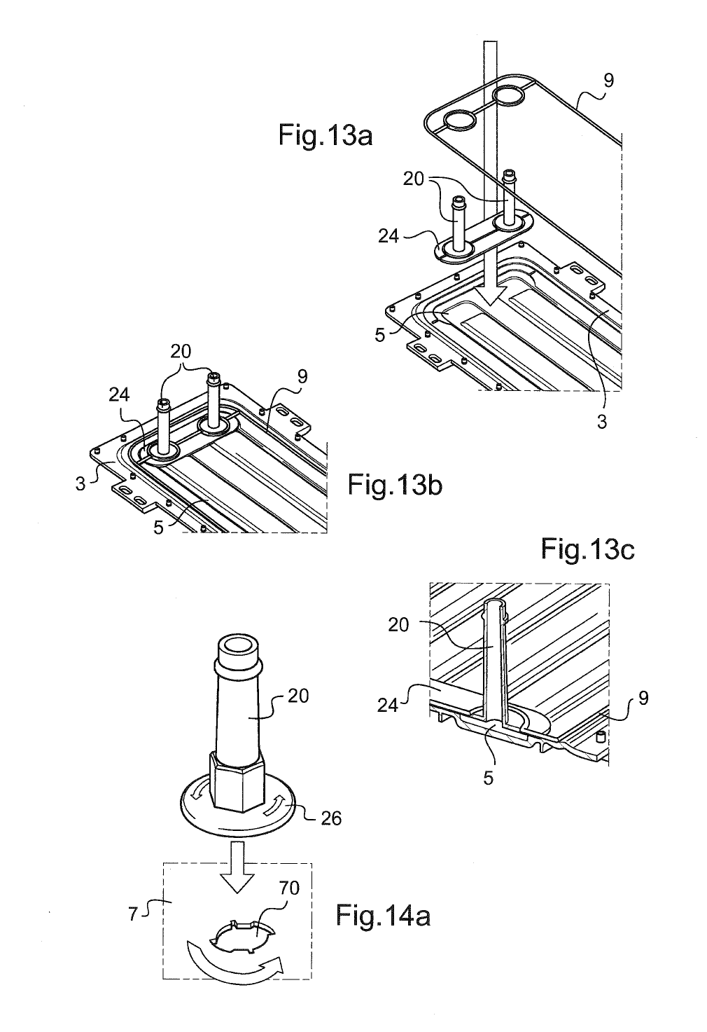

FIGS. 13a to 13c show a schematic representation in perspective of a second coupling tube fixing mode,

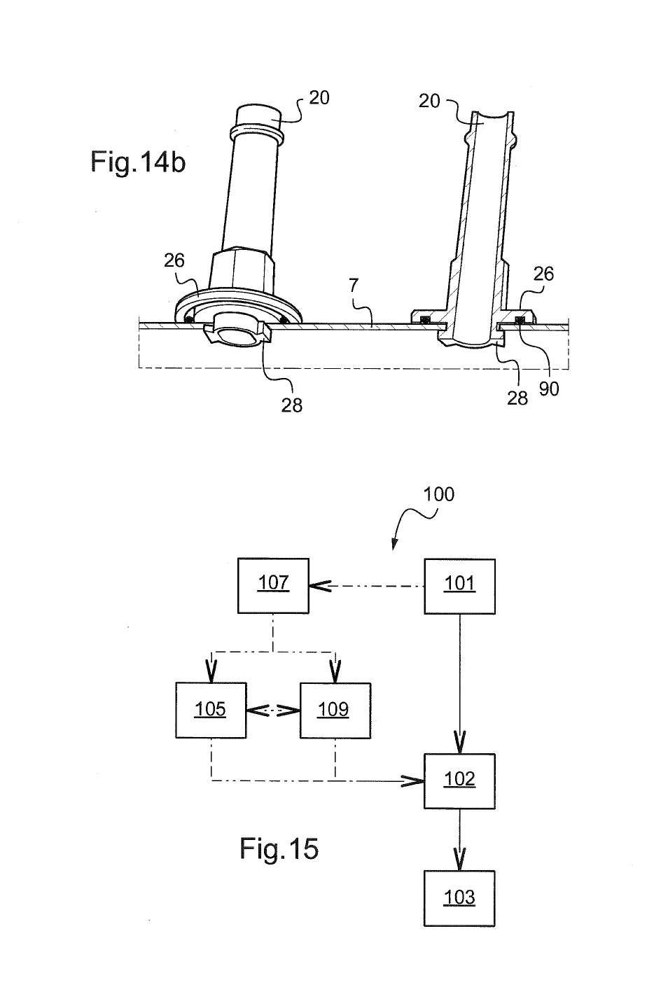

FIGS. 14a and 14b show a schematic representation in perspective of a third coupling tube fixing mode,

FIG. 15 shows a diagram of the steps of a manufacturing method for a heat exchange plate according to the invention.

The elements that are identical in the different figures bear the same references.

FIGS. 1 to 14b show schematic representations of a heat exchange plate 1 from different viewpoints and according to different embodiments.

In these figures, a heat exchange plate 1 is notably represented comprising a base 3 made of molded plastic material. The base 3 comprises at least one channel 6 in which a heat-transfer fluid or refrigerant circulates between an inlet and an outlet for heat-transfer fluid or refrigerant 20 (visible in FIGS. 7 and 11 to 14b). The heat exchange plate 1 also comprises a contact plate 7, intended to come into contact with the battery to be thermally regulated. The contact plate 7 is fixed onto the base 3 in order to cover the channels 6 and thus delimit, with the base 3, at least one duct 5 intended for the flow of a heat-transfer fluid or refrigerant. The contact plate 7 is suitable for coming into direct contact with the heat-transfer fluid or refrigerant which circulates in each duct (5). The contact plate 7 is preferentially made of thermo-conductive material in order to ensure good heat exchanges between the heat-transfer fluid or refrigerant and the battery. The contact plate 7 can thus be made of metal like aluminum or even of plastic material with enhanced thermal conductivity. The contact plate 7 can also be covered, on its face in contact with the battery, with a sheet improving the thermal conductivity.

The fact that the base 3 is made of molded plastic material and that the contact plate 7 is made of thermo-conductive material makes it possible for the heat exchange plate to be particularly inexpensive, while retaining an optimal thermal conductivity between the battery and the heat-transfer fluid.

In addition, the base 3 made of plastic material allows for a thermal insulation with the elements situated opposite the contact plate 7 and also allows for a focusing of the heat exchanges in the ducts 5 because of the low thermal conductivity of the plastic materials. The base 3 made of plastic material also allows for a wider variety of fixing modes with the contact plate 7 but also with the support onto which it is fixed, for example by the addition of specific fixing tabs 38. The base 3 made of molded plastic material, through its production method, also allows for the addition of elements or of particular shapes directly at the stage of its manufacture, which commensurately reduces its cost.

The fixing of the contact plate 7 on the base 3 can be produced by a plurality of embodiments.

FIGS. 1 and 2 show a first embodiment of the fixing of the contact plate 7 onto the base 3 according to two variants. This first fixing mode consists in fixing the contact plate onto the base 3 by means of an overmolded complementary part 36, passing through both the contact plate 7 and the base 3. In this embodiment, said complementary part is of substantially I-shaped cross section.

According to the second variant illustrated by FIG. 2, the complementary part 36 is overmolded on the periphery of the base 3 and of the contact plate 7 to fix them to one another. In this embodiment, said complementary part is of substantially C-shaped cross section.

FIG. 3 shows yet another embodiment of the fixing of the contact plate 7 onto the base 3. Here, the fixing is produced by screwing. At least one screw 31 passes through the contact plate 7 and the base 3 in order to be screwed into a nut 32 for example crimped into the base 3 or overmolded thereby.

FIGS. 4 and 5 show an embodiment of the fixing of the contact plate 7 onto the base 3 by crimping. To produce this fixing, the contact plate 7 includes extensions 72 on its periphery which are folded back over the base 3. Each extension 72 allows the contact plate 7 to encircle the peripheral edge of the base 3. The peripheral edge extends by protrusion from a main part of the base 3 forming a collar of lesser thickness compared to the thickness of said main part of the base 3.

FIGS. 6 and 7 show an embodiment of the fixing of the contact plate 7 onto the base 3 by clipping. The base 3 here includes a notch 39 produced on one of its sides. One side of the contact plate 7, of a form substantially complementing that of said notch 39, to within fitting tolerances, is inserted into the notch 39 and the side of said contact plate 7 opposite that inserted into the notch 39 is held against the base 3 by means of at least one added element 37 which is fixed by clipping onto the base 3. The added element 37 can extend over the entire length of the side of the contact plate 7 and thus include several clipping points for an optimal fixing. It can also be extended over the lateral sides to further improve its fixing. Its same lateral sides may also include at least one deformable tongue 40 intended to keep the contact plate 7 constrained against the base 3 by a compression force.

FIGS. 8 and 9 show yet another embodiment of the fixing of the contact plate 7 onto the base 3. Here, the fixing is produced by the casting of studs 34, made of a piece with the material of the base 3 and passing through the contact plate 7. The melting of each of the studs 34, for example by ultrasound, makes it cover a part of the contact plate 7 and thus fixes it onto the base 3.

The fixing means cited previously are placed at the periphery of the contact plate 7 and of the base 3. However, as illustrated by FIGS. 8 and 9, it is perfectly possible to imagine having fixing means such as the screws 31, the overmolded complementary parts 36 or even the studs 34 placed between the ducts 5 in order to improve the seal-tightness of each of the ducts 5 by avoiding any unwanted passage of fluid from one duct 5 to another.

Preferably, the means and methods for fixing the contact plate 7 onto the base 3 are implemented in such a way that the contact surface between the battery and the contact plate 7 remains planar, for example by the use of chamfers on the contact plate 7.

In order for the heat exchange plate 1 to be seal-tight and more particularly for the ducts 5 to be seal-tight such that the heat-transfer fluid or refrigerant circulating therein does not leak, the heat exchange plate 1 can include at least one seal 9 placed between the base 3 and the contact plate 7. Such a seal 9 acts as gasket, but also as expansion joint, absorbing and neutralizing the expansion and contraction of the different parts that make up the heat exchange plate 1 under the effect of the thermal variations undergone.

The seals 9 can be overmolded seals equally on the base 3 as illustrated by FIGS. 1, 4 and 6 or even on the contact plate 7 as illustrated by FIG. 2. The seals 9 can also be placed in the grooves 90 produced for this purpose on the base 3, as illustrated by FIG. 2 by way of example. The seals 9 can be placed at the periphery of the heat exchange plate as shown by FIGS. 1, 2, 3, 4 and 6, but they can also be placed between the ducts 5 as shown by FIG. 8.

The ducts 5 in which the heat-transfer fluid or refrigerant circulates can include disruptors 11 intended to disturb the flow thereof and thus improve the heat exchanges between the fluid and the contact plate 7. These disruptors 11 can be made of a piece of the same material as the base 3, as shown in FIG. 1 and thus be produced when manufacturing said base 3. The disruptors 11 can, on the other hand, be added parts, for example made of metal, and then placed in the ducts 5.

Furthermore, the base 3 can include within it a phase-change material (not represented) in order to improve the thermal management of the battery. This phase-change material may be incorporated into the base 3 in a housing provided for this purpose and be in different forms such as, for example, in granular form, contained in a porous structure, or even in the form of an insert. The addition of such a phase-change material is advantageously intended to favor the uniformity of temperature of the heat exchange plate 1, therefore a better thermal regulation of the battery, notably in the transient phases of abrupt change of temperature experienced, for example, during the rapid charging or discharging of the battery produced during the period of braking or of acceleration of the vehicle. The addition of such a phase-change material therefore makes it possible to reduce the thermal load peaks and therefore thermally dimension the exchanger in its useful range of operation. According to an alternative embodiment, the heat exchange plate 1 includes a base 3 configured with disruptors 11 and phase-change materials, which increases the thermal uniformity of the plate, thus favoring the thermal regulation of the battery.

The fluid inlet and outlet 2 of the exchange plate 1 are generally produced on the contact plate 7 and each includes a coupling tube 20 onto which is coupled a heat-transfer fluid or refrigerant intake or discharge duct.

The placement and the fixing of the coupling tubes 20 can, like the fixing of the contact plate 7 onto the base 3, be produced according to a plurality of embodiments.

FIGS. 11, 12a, and 12b show a first embodiment of the fixing of the coupling tubes 20. In this embodiment, the coupling tubes 20 are inserted into the orifices 70 of the contact plate 7. An annular seal 90 ensures the seal-tightness at the interface between the coupling tubes 20 and the contact plate 7. The coupling tubes 20 include a protruding flange 22 blocking their passage through the orifices 70. The coupling tubes 20 are swaged at their end passing through the orifices 70 to spread apart the walls of the coupling tubes 20 and increase the diameter and thus block the contact plate 7 on one side by the swaging and on the other by the flange 22.

FIGS. 13a, 13b and 13c show an alternative embodiment of the placement and fixing of the coupling tubes 20. In this embodiment, the coupling tubes 20 include a baseplate 24 at their base. In FIGS. 13a, 13b and 13, the baseplate 24 is common to both coupling tubes 20, but it is perfectly possible to imagine having each coupling tube 20 associated with a baseplate 24.

The coupling tubes 20 and their baseplate 24 are here inserted between the base 3 and the contact plate 7 above the ducts 5 to form the inlet and outlet 2 thereof by passing through the contact plate at the orifices 70. The seals 9 ensuring the seal-tightness between the base 3 and the contact plate 7 are also present at the baseplate or baseplates 24 and encircle the coupling tubes 20 in order to ensure the seal-tightness between the baseplate or baseplates 24 and the contact plate 7. When the contact plate 7 is fixed to the base 3, the coupling tubes 20 are thus blocked and fixed because of the presence of the baseplate or baseplates 24 previously inserted between the base 3 and the contact plate 7.

FIGS. 14a and 14b show another embodiment of the placement and the fixing of coupling tubes 20. The coupling tubes 20 include a fixing of quarter-turn type. In effect, the coupling tubes 20 here include a collar 26 and at least two diametrically opposite keys 28 at one of the ends of said coupling tubes 20. The contact plate 7 includes an orifice 70 including at least two notches for the passage of the keys 28. The distance between the keys 28 and the collar 26 corresponds to the thickness of the contact plate 7, so the coupling tube 20 is inserted into the orifice 70, the keys pass through the dedicated notches and then a rotation of the order of 45° is applied in order to block said coupling tube 20, the lips of the orifices 70 of the contact plate 7 then being placed between the keys 28 and the collar 26. In order to ensure the seal-tightness of this fixing, a seal 90 can be fitted between the collar and the surface of the contact plate 7.

Given the fact that a heat exchange plate 1 is intended to thermally regulate a predefined number of battery cells, a plurality of heat exchange plates may be joined to one another via an appropriate link means (not represented), such that the number of cells to be thermally regulated can vary as a function of the number of plates used.

By way of example, such a link means consists of a longitudinal element, of rail type, having a substantially H-shaped cross section, in as much as it comprises two end walls linked together by an internal wall at right angles relative to said end walls. By such an arrangement of the walls relative to one another, the rail defines two adjacent recesses having openings directed in opposite directions. Each of the adjacent recesses of the rail is suitable for receiving a fixing tab 38 of a heat exchange plate 1.

The end branches of the rail comprise a top branch and a bottom branch which are parallel to one another.

The top branch is substantially planar and comprises, in line with the internal wall, fixing means which make it possible to securely link the cells of the battery to the assembly consisting of at least two heat exchange plates linked together via a link rail.

The bottom branch can include cut-outs of a form substantially complementing fixing spurs made of a piece with the fixing tab 38 of the heat exchange plate. The assembly consisting of the tenons and the associated cut-outs makes it possible to index the fixing rail on the heat exchange plate. Such an assembly further makes it possible to align the different heat exchange plates with one another.

The fixing rails make it possible to link together a plurality of heat exchange plates, such that the thermal power supplied to the battery varies according to the number of heat exchange plates.

Regardless of the number of heat exchange plates, the latter are contiguous to the rails.

Preferably, each rail is made of plastic material which confers upon it a property of electrical insulation relative to the added battery.

Alternatively, all or part of the outline of a heat exchange plate, or of each of the end plates of an assembly of a plurality of heat exchange plates, can receive an electrical insulation means. By way of example, such an electrical insulation means consists of a rail made of electrically insulating material, preferentially of plastic material. Such a rail is of substantially L-shaped cross section, in as much as it comprises a planar portion intended to extend contiguously to the contact plate 7 and a bent-back portion forming a right-angled lip intended to protect the join between the contact plate 7 and said base 3.

According to a variant embodiment not represented, the heat exchange plate makes it possible to regulate the temperature of the battery cells positioned directly above and below. To this end, each heat exchange plate comprises a base 3 interposed between two identical contact plates 7, the base 3 and the two contact plates 7 respectively taking on all the features described in the preceding embodiments.

The recourse to a base 3 made of plastic material makes it possible:
to orient the heat exchange primarily toward the contact plate 7 which is intended to come into contact against the battery cells,
to use only a mechanical assembly which is simpler and less costly than an assembly by welding or brazing,
to increase the corrosion resistance of the heat exchange plate,
to mold appropriate fixing means such as, for example, clips or hooks,
to improve the vibration resistance, which commensurately reduces any leak of the refrigerant,
to produce, by molding, the ducts for circulation of a heat-transfer fluid or refrigerant, in forms more complex than those made possible by stamping,
to directly incorporate a phase-change material in the base 3,
to more easily recycle the heat exchange plate.

The invention relates also to a manufacturing method 100 for an exchange plate 1 as described previously. This method is illustrated by FIG. 15.

The manufacturing method comprises the following steps:
a step 101 of molding of a base 3 made of plastic material, said base 3 including a circuit of ducts 5 for circulation of heat-transfer fluid or refrigerant between an inlet and an outlet for heat-transfer fluid,
a step 102 of positioning of a contact plate 7 made of thermo-conductive material on the base 3 in order to cover the ducts 5, and
a step 103 of fixing of the contact plate 7 onto the base 3 in a seal-tight manner.

The manufacturing method 100 can include, between the step 101 of molding of the base 3 and the step 102 of positioning of the contact plate 7, an intermediate step 105 of placement of at least one seal 9 on one or other of the base 3 or of the contact plate 7. This step 105 can be performed by the overmolding of at least one seal 9 on one or other of the base 3 or of the contact plate 7, or else by a placement of seals 9 in dedicated grooves 90 produced on the base 3 in the step 101 of molding thereof. The aim of this step 105 is to ensure the future seal-tightness of the ducts 5.

The manufacturing method 100 can include, between the step 101 of molding of the base 3 and the step 102 of positioning of the contact plate 7, before or after the intermediate step 105 and independently thereof, a step 109 of placement of disruptors 11 in the ducts 5 when the latter are not produced in the step 101 of molding of the base 3.

The manufacturing method 100 can also include a step 107 of placement and fixing of the coupling tubes 20. This step 107 can be performed according to one of the embodiments cited previously. Thus, this step 107 of placement and of fixing of the coupling tubes 20 can be performed by fitting coupling tubes 20 in the orifices 70 of the contact plate 7, by the insertion of coupling tubes 20 provided with baseplates 24 between the base 3 and the contact plate 7 or even by the fixing of quarter-turn type in the contact plate 7.

Preferably, this step 107 of placement and of fixing of the coupling tubes 20 can be performed prior to the step 102 of positioning of the contact plate 7 and before the intermediate step 105.

The step 103 of fixing of the contact plate 7 onto the base 3 can be performed according to one of the embodiments cited previously. The fixing of the contact plate 7 onto the base 3 can thus be performed by means of at least one screw 31 passing through the contact plate 7 and the base 3 and being screwed into a nut 32. The nut 32 can notably be crimped into the base 3 or even overmolded thereby in the molding step 101.

The step 103 can also be performed by overmolding of a complementary plastic part 36 inside contiguous orifices passing through the contact plate and the base 3. The plastic part 36 can, alternatively, be overmolded at the periphery of the base 3 and of the contact plate 7. The orifices of the base 3 are advantageously produced during the molding step 101.

The step 103 can also be performed by casting at least one stud 34 made of a piece with the base 3 and passing through the contact plate 7. The stud 34 produced in the molding step 101 can be melted, for example by ultrasound and thus partly cover the contact plate 7.

Finally, the step 103 can be performed by crimping, by snap-fitting of the contact plate 7 onto the base 3, or even by bonding.

During the molding step 101, a housing can also be produced (not represented) in order to receive a phase-change material. Said phase-change material can then be introduced into its dedicated housing in a step devoted to this placement, independently of the other steps of the manufacturing method.

Because the heat exchange plate 1 includes a base 3 made of plastic material and a contact plate 7 made of thermo-conductive material, the heat exchange plate 1 is inexpensive to manufacture. In effect, its manufacturing cost is lower because it is fast by virtue of the fact that it does not require lengthy brazing, but also the material used is inexpensive. Furthermore, the use of the plastic material to produce the base 3 allows for a great degree of modularity and flexibility of design such that it becomes possible to incorporate certain elements like the disruptors 11, the fixing tabs 38, the grooves 90 for receiving the seals 9 or even the fixing studs 34.

1. A heat exchange plate for battery thermal management, comprising a base including at least one channel for the circulation of heat-transfer fluid or refrigerant between an inlet and an outlet for said fluid, and further comprising, fixed to said base, a contact plate intended to come into contact with the battery to be thermally regulated and covering each channel to form at least one duct for the circulation of heat-transfer fluid or refrigerant, the base being made of molded plastic material, the contact plate being produced in a thermo-conductive material.

2. The heat exchange plate as claimed in claim 1, wherein the contact plate is made of metal.

3. The heat exchange plate as claimed in claim 1, wherein the base further comprises at least one seal placed between said base and the contact plate to ensure the seal-tightness of the ducts.

4. The heat exchange plate as claimed in claim 1, wherein the fixing of the contact plate onto the base is produced by screwing.

5. The heat exchange plate as claimed in claim 1, wherein the fixing of the contact plate onto the base is produced by a casting of at least one stud made of a piece with the material of the base and passing through the contact plate.

6. The heat exchange plate as claimed in claim 1, wherein the fixing of the contact plate onto the base is produced by means of an overmolding of at least one complementary plastic part.

7. The heat exchange plate as claimed in claim 1, wherein the fixing of the contact plate onto the base is produced by means of a crimping of said contact plate on the base.

8. The heat exchange plate as claimed in claim 1, wherein the base includes a notch produced on one of its sides and into which is inserted a side of the contact plate, the side of said contact plate opposite that inserted into the notch being held against the base by means of at least one added element that clips onto the base.

9. The heat exchange plate as claimed in claim 1, wherein the fluid inlet and outlet are produced on the contact plate and that each includes a coupling tube.

10. The heat exchange plate as claimed in claim 9, wherein each coupling tube includes a flange and the fixing of the coupling tube onto the contact plate is produced by insertion of said coupling tube into a dedicated orifice (70) of the contact plate, then by a crimping of the end of said coupling tube passing through the orifice to block the contact plate between the flange and the crimped end of said tube.

11. The heat exchange plate as claimed in claim 9, wherein the coupling tubes include a baseplate of a diameter greater than the orifices of the contact plate through which the coupling tubes pass through said contact plate and that said baseplates are inserted between the contact plate and the base.

12. The heat exchange plate as claimed in claim 9, wherein the coupling tubes include a collar and at least two keys and wherein the contact plate includes orifices including at least two notches for the passage of the keys, the fixing of the coupling tubes being produced by rotation of said coupling tubes in the orifices in order to place the lips of the orifices of the contact plate between the keys and the collar.

13. The heat exchange plate as claimed in claim 1, further comprising a phase-change material and/or a heating device and/or disruptors.

14. A manufacturing method for a heat exchange plate comprising:
molding of a base made of plastic material including at least one channel for circulation of heat-transfer fluid or refrigerant between an inlet and an outlet for heat-transfer fluid;
positioning of a contact plate made of thermo-conductive material on the base in order to cover each channel; and
fixing of the contact plate onto the base in a seal-tight manner.

15. The manufacturing method as claimed in claim 14, wherein, between molding of the base and positioning of the contact plate, an intermediate step is carried out for placement of at least one seal on one or other of the base or of the contact plate in order to ensure the seal-tightness of the duct delimited by a channel of the base and the contact plate.

16. The manufacturing method as claimed in claim 14, wherein said method includes placement and of fixing of the coupling tubes.
